(19) United States
(12) Patent Application Publication
(10) Pub. No.: US 2025/0178204 A1
(43) Pub. Date: Jun. 5, 2025

(54) ADJUSTING A VIRTUAL RELATIVE POSITION IN A VIRTUAL ROBOT WORK CELL

(71) Applicant: ABB SCHWEIZ AG, Baden (CH)

(72) Inventors: Changnian Qian, Shanghai (CN); Chenyang Liu, Shanghai (CN); Weidong Wang, Shanghai (CN)

(21) Appl. No.: 19/042,806

(22) Filed: Jan. 31, 2025

Related U.S. Application Data
(63) Continuation of application No. PCT/CN2022/115528, filed on Aug. 29, 2022.

(51) Int. Cl. B25J 9/16

(52) U.S. Cl. CPC B25J 9/1692; B25J 9/1671

(57) ABSTRACT

A fixture and a method for transferring a bundled cardboard. The fixture for transferring a bundled cardboard includes a frame extending substantially in a first direction and having an upper side and a lower side. The fixture also has a first gripper attached to the frame at a first place adjacent to the upper side and having a gripping plate extending in a second direction perpendicular to the first direction. The gripping plate includes a gripping surface adapted to engage with a first surface of the bundled cardboard. The fixture also includes a second gripper attached to the frame at a second place adjacent to the lower side and having at least one clamping arm.

### FIELD

Example embodiments of the present disclosure generally relate to robot work cell simulation, and more specifically, to methods, apparatuses, systems and computer readable media for adjusting a virtual relative position in a virtual robot work cell.

### BACKGROUND

A digital twin is a digital representation of a physical object, process or service. A digital twin can be a digital replica of an object in the physical world. The digital twin technology can be used to replicate processes in order to collect data to predict how they will perform, thereby allowing the prevention of costly failures in physical objects. Therefore, it is well used in the robot industry.

For example, during the process of construction of a robot work cell. At first, during the design phase, a virtual robot work cell will be established in a computer program for simulating the robot work cell to be constructed. When the simulation is complete, a physical robot work cell will be constructed and tested. During the testing phase, the dimension and position of the components in the robot work cell may be adjusted. In this case, the parameters in the virtual robot work cell may vary from the adjusted robot work cell. In this regard, in order to simulate the constructed robot work cell, the parameters in the virtual robot work cell must be synchronized with the constructed robot work cell. Therefore, it is desired to propose an efficient solution for synchronizing between constructed robot work cell and its digital replica.

### SUMMARY

Example embodiments of the present disclosure provide solutions for synchronizing the positions of components in the real environment and the virtual environment.

In a first aspect, example embodiments of the present disclosure provide a method for adjusting a virtual relative position in a virtual robot work cell simulating the robot work cell. The method comprises obtaining, from a controller for controlling a robot in a robot work cell, a relative position between the robot and an object carrier in the robot work cell. The method further comprises adjusting, in a virtual robot work cell simulating the robot work cell, a virtual relative position between a virtual robot corresponding to the robot and a virtual object carrier corresponding to the object carrier based on the relative position. With these embodiments, the relative position can be read from the physical controller for the robot, for example through a specific interface. The relative position between the robot and the object carrier can thus be automatically obtained and digitally analyzed, thereby avoiding manual measurements so that the efficiencies and accuracy of the position synchronization between the physical work cell and the virtual work cell can be increased.

In some example embodiments, adjusting the virtual relative position comprises: determining a base height of the virtual object carrier based on the relative position and a virtual robot height of the virtual robot; determining a height compensation based on a cell configuration of the robot work cell; and adjusting a height of the virtual object carrier based on the base height and the height compensation. With these embodiments, the cell configuration may be directed to the using of visual detection equipment, such as camera or sensors, and the shape of the object carrier. The cell configuration may affect the selection of the position reference in the virtual work cell. Therefore, by determining the height compensation in consideration of the cell configuration, the accuracy of the position adjustment can be increased.

In some example embodiments, adjusting the relative position further comprises: determining a virtual target horizontal position of the virtual object carrier based on the relative position and a virtual horizontal position of the virtual robot; and adjusting a virtual position of the virtual object carrier to the virtual target horizontal position. With these embodiments, by separating the vertical and horizontal position adjustment, the adjustment procedure can be simplified.

In some example embodiments, determining the base height comprises: obtaining the virtual robot height of the virtual robot; determining a relative height based on the relative position; and determining a difference between the virtual robot height and the relative height as the base height. Generally, the relative position may indicate a robot reference point at the robot and a carrier reference point at the surface of the object carrier to describe the relative positions. With these embodiments, by treating the virtual robot as the basis for positioning adjustment, the position of the virtual robot can be maintained without any adjustment thereby simplifying the adjustment procedure.

In some example embodiments, determining the height compensation comprises: obtaining an original virtual surface height of a surface of the virtual object carrier; obtaining a virtual object height of an virtual object at a point where the virtual object appears on the virtual object carrier; and determining a difference between the original virtual surface height and the object virtual height as the height compensation. With these embodiments, when the object appears not on the surface of the object carrier for simulating reasons, the height can be compensated so that the height adjustment can be more accurate.

In some example embodiments, determining the height compensation comprises: in response to determining that the robot work cell is configured with a camera above a surface of the object carrier, determining that the height compensation is zero. With these embodiments, when a camera is configured for providing visual data of the objects, the objects are generally located on the surface of the carrier. Therefore, there is no need to compensate the base height.

In some example embodiments, the method further comprises: adjusting a position of a virtual camera based on the virtual target horizontal position. The relative position of a camera and the object carrier are fixed. With these embodiments, after the target horizontal position is determined, the virtual camera as a peripheral device can be adjusted for example, based on the adjustment distance.

In some example embodiments, determining the height compensation comprises: in response to determining that the robot work cell is configured with a sensor for sensing objects on a surface of the object carrier, obtaining a virtual sensor height of a virtual sensor corresponding to the sensor in the virtual robot work cell; obtaining a virtual object height of a virtual object at a point where the virtual object appears on the virtual object carrier; and determining a difference between the virtual sensor height and the virtual object height as the height compensation. The sensor is usually located at the edge of the object carrier to detect the position of the object travelling through a detection range of the sensor. With these embodiments, the height of the sensor corresponds to the original height of the virtual object carrier before the adjustment and can be used to calculate the height compensation.

In some example embodiments, the method further comprises adjusting a position of the virtual sensor based on the virtual target horizontal position. The relative position between the sensor and the object carrier are also generally fixed. With these embodiments, after the target horizontal position is determined, the virtual sensor as a peripheral device can be adjusted for example, based on the adjustment distance of the object carrier.

In some example embodiments, the method further comprises: in response to determining that the object carrier is linear, obtaining a virtual robot orientation of the virtual robot; and adjusting a virtual orientation of the virtual object carrier based on the virtual robot orientation and a relative orientation between the robot and an object carrier. The relative orientation generally indicates the relative orientation between the object carrier and the robot in a plurality of axes. With these embodiments, the orientation of the object carrier can also be adjusted relative to the virtual robot.

In some example embodiments, the method further comprises: in response to determining that the object carrier is circular, determining a center of the virtual object carrier as an origin of a virtual object carrier coordinate system of the virtual object carrier; and adjusting an orientation of the virtual object carrier coordinate system based the virtual robot orientation and a relative orientation between the robot and an object carrier. With these embodiments, when the object carrier is circular, the center of the object carrier would be the origin of a virtual object carrier coordinate system of the virtual object carrier, the virtual object carrier coordinate system can be adjusted.

In some example embodiments, the method further comprises: in response to determining that the robot work cell further comprises a further robot, obtaining, from a further controller for controlling the further robot, a further relative position between the object carrier and the further robot; and adjusting, in the virtual robot work cell, a virtual position of a virtual further robot corresponding to the further robot based on the relative position and the further relative position. With these embodiments, the position of all components in the robot work cell will be adjusted relative to the first robot which may be the one closest to the loading position of the object.

In a second aspect, example embodiments of the present disclosure provide an apparatus for adjusting a virtual relative position in a virtual robot work cell. The apparatus comprises: a relative position obtaining unit configured to obtain, from a controller for controlling a robot in a robot work cell, a relative position between the robot and an object carrier in the robot work cell. The apparatus further comprises a virtual relative position adjusting unit configured to adjust, in a virtual robot work cell simulating the robot work cell, a virtual relative position between a virtual robot corresponding to the robot and a virtual object carrier corresponding to the object carrier based on the relative position.

In a third aspect, example embodiments of the present disclosure provide a system for adjusting a virtual relative position in a virtual robot work cell. The system comprises: a computer processor coupled to a computer-readable memory unit, the memory unit comprising instructions that when executed by the computer processor implements the method for adjusting a virtual relative position in a virtual robot work cell.

In a fourth aspect, example embodiments of the present disclosure provide a computer readable medium having instructions stored thereon, the instructions, when executed on at least one processor, cause the at least one processor to perform the method for adjusting a virtual relative position in a virtual robot work cell.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIG. 1 illustrates a schematic block diagram of an example robot working system in which example embodiments of the present disclosure can be implemented;

FIG. 2 illustrates a schematic flowchart of a method for adjusting positions of components of a robot work cell in a virtual robot work cell in accordance with embodiments of the present disclosure;

FIGS. 3A-3C illustrate a schematic flowchart of a method for adjusting heights of components of a robot work cell in a virtual robot work cell in accordance with embodiments of the present disclosure;

FIGS. 4A-4C illustrate a schematic block diagram of a virtual robot work cell with different configurations in accordance with embodiments of the present disclosure where the object carrier is linear;

FIGS. 5A-5C illustrate a schematic block diagram of a virtual robot work cell with different configurations in accordance with embodiments of the present disclosure where the object carrier is circular;

FIG. 6 illustrates a schematic block diagram of a virtual robot work cell with two robots in accordance with embodiments of the present disclosure;

FIG. 7 illustrates a schematic diagram of an apparatus for adjusting positions of components of a robot work cell in a virtual robot work cell in accordance with embodiments of the present disclosure;

FIG. 8 illustrates a schematic diagram of a system for implementing a method in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As discussed above, in order to simulate the constructed robot work cell, the parameters need to be synchronized with the constructed robot work cell. Conventionally, the users manually tune the dimensions, locations, and orientations of parts like conveyor, robot, and camera to make them align with the real cell. However, the dimensions of the components in the constructed robot work cell are difficult to be measured manually. In the meantime, the manual measurements may have relatively low accuracy.

In order to at least partially solve the above and other potential problems, a new method is provided for automatic adjusting relative positions of components of a robot work cell in a virtual robot work cell according to embodiments of the present disclosure. In general, the dimensions, positions of corresponding components in the virtual robot work cell can be updated (or partially updated) automatically with the information derived from the relative position between the robot and the object carrier which can be read from real controller for example by calling controller APIs. In this way, the manual measurements can be avoided so that the efficiencies and accuracy of the position synchronization between the physical work cell and the virtual work cell can be increased.

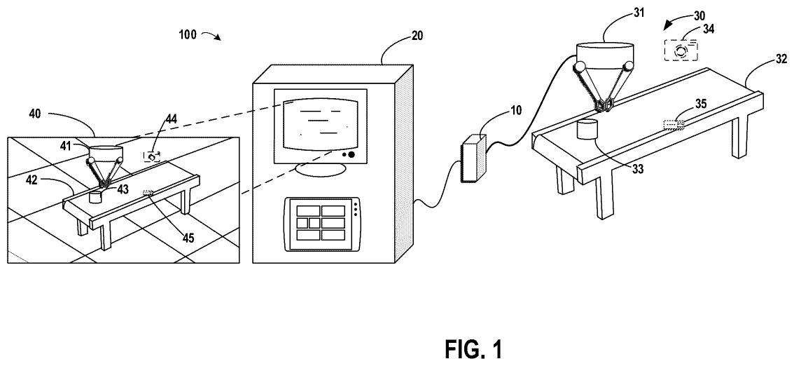

FIG. 1 illustrates a schematic block diagram of an example robot work system 100 in which example embodiments of the present disclosure can be implemented. In FIG. 1, the robot work system 100 comprises a robot work cell 30. The robot work cell 30 generally comprises a robot 31 and an object carrier 32 under the robot 31. In the illustrated embodiments, the robot 31 may be a pick and place robot and the object carrier 32 may be a conveyor. The robot 31 is coupled to a controller 10 and is controlled by the controller 10 to pick up objects 33 on the surface of the object carrier 32. In order to facilitate the operation of the robot 33, other visual detection equipment may be optionally provided, such as a camera 34 or a sensor 35. The controller 10 is also coupled to a computing device 20. The computing device 20 may communicate with the controller 10 to obtain information about the robot work cell 30. Further, the computing device 20 can perform simulations of the robot work cell 30 and display the simulation on a display of the computing device 20 in real time. As illustrated in FIG. 1, a virtual robot work cell 40 is displayed. The virtual robot work cell 40 comprises a virtual robot 41 corresponding to the robot 31, a virtual object carrier 42 corresponding to the object carrier 32. The virtual robot work cell 40 may also comprise a virtual camera 44 or a virtual sensor 45. In addition, the virtual robot work cell 40 may be referred to as a digital twin of the robot work cell 30. The dimensions and positions of components in the virtual robot work cell 40 should be synchronized with that in the robot work cell 30.

It should be appreciated that the robot can be any other industry robot and the number of the robots may be more than one. Further, the object carrier may also be any other working platform to support objects and the number of the object carrier may also be more than one.

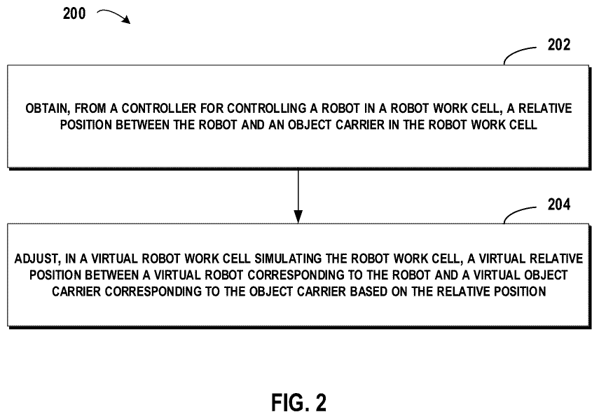

Hereinafter, reference will be made to FIGS. 2-6 for more details about the method for adjusting a virtual relative position in a virtual robot work cell in accordance with the present disclosure.

FIG. 2 illustrates a schematic flowchart of a method 200 for adjusting positions of components of a robot work cell in a virtual robot work cell in accordance with embodiments of the present disclosure. The method 200 may be implemented by the computing device 20 in FIG. 1.

At 202, the computing device 20 obtains, from a controller 10 for controlling a robot 31 in a robot work cell 30, a relative position between the robot 31 and an object carrier 32 in the robot work cell 30. In the robot operation, one of the important parameter is the relative position between the robot and the surface of the object carrier. The relative are usually defined and stored in the controller.

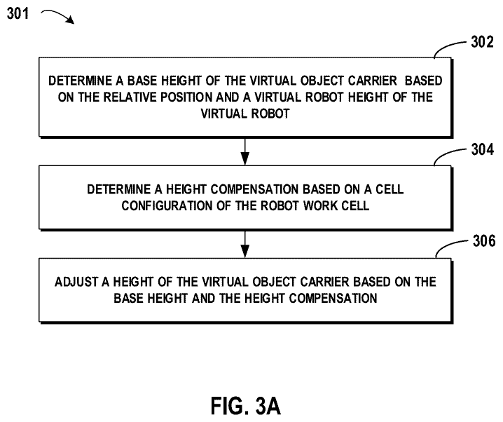

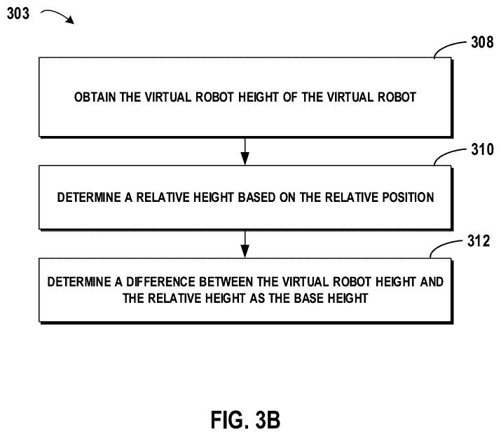

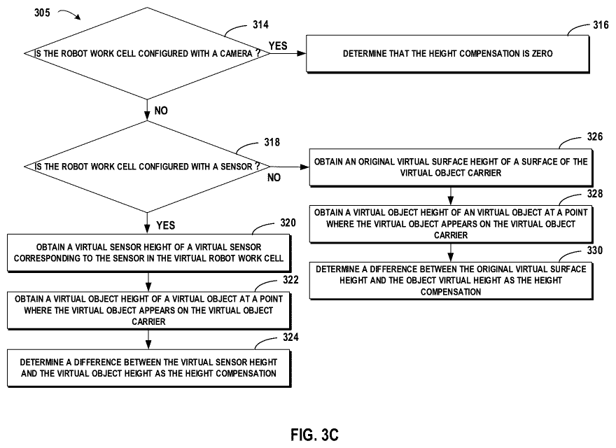

At 204, the computing device 20 adjusts, in a virtual robot work cell 40 simulating the robot work cell 30, a virtual relative position between a virtual robot 41 corresponding to the robot 31 and a virtual object carrier 42 corresponding to the object carrier 32 based on the relative position. In this embodiment, the relative position between the virtual robot 41 and the virtual object carrier 42 includes both relative distance in the vertical orientation and horizontal orientation. The determination of the relative height will be described in details with reference to FIGS. 3A-3C later.

In some example embodiments, the virtual robot 41 may serve as the basis for adjustment. That is, the virtual robot 41 is fixed and the virtual object carrier 42 is adjusted to achieve the relative position. For example, if the relative distance is larger than the current distance, the corresponding dimension of the virtual object carrier 42 can be reduced to increase the current distance to reach the relative distance. Alternatively, the virtual object carrier 42 may serve as the basis for adjustment. That is, the virtual object carrier 42 is fixed and the virtual robot 41 is adjusted to achieve the relative position.

In this way, the relative position between the virtual robot 41 and the virtual object carrier 42 can be automatically updated thereby increasing the accuracy and efficiency of work cell synchronization.

FIG. 3A illustrates a schematic flowchart of a method 301 for adjusting heights of components of a robot work cell in a virtual robot work cell in accordance with embodiments of the present disclosure. The method 301 may be implemented by the computing device 20 in FIG. 1.

At 302, the computing device 20 determines a base height of the virtual object carrier 42 based on the relative position and a virtual robot height of the virtual robot 41. The base height may indicate a distance from a reference point of the virtual object carrier 42 to the floor of the virtual robot work cell 40. The method for determining a base height will be described in details with regard to FIG. 3B.

FIG. 3B illustrates a schematic flowchart of a method 303 for determining a base height in accordance with embodiments of the present disclosure. The method 303 may be implemented by the computing device 20 in FIG. 1. At 308, the computing device 20 obtains the virtual robot height of the virtual robot 41. In this embodiment, the virtual robot 41 serves as the basis for adjustment. A virtual robot height is a distance from a reference point on the virtual robot to the surface of the floor of the virtual robot work cell 40. In some embodiments, the virtual robot 41 may be configured with a base coordinate system. The origin of the coordinate system of the virtual robot 41 can serve as the reference point.

At 310, the computing device 20 determines a relative height based on the relative position. The relative height may be a vertical component of the relative position. At 312, the computing device 20 determines a difference between the virtual robot height and the relative height as the base height. In this way, the distance from a reference point of the virtual object carrier 42 to the floor of the virtual robot work cell 40 can be determined.

The relative position may indicate a distance from a reference point of the robot 31 to the surface of the object carrier 32. However, when the reference point of the virtual object carrier 42 is not located on surface of the virtual object carrier 42, the base height needs to be tuned with a height compensation.

Back to FIG. 3A, the computing device 20 determines a height compensation based on a cell configuration of the robot work cell at 304. In some example embodiments, the cell configuration may comprise the shape of the object carrier, involvement of visual detection equipment such as a camera or sensor, and the number of the robots. The cell configuration may be read from configuration information of the virtual work cell. The height compensation is associated with the cell configuration and will be described in details with reference to FIG. 3C.

FIG. 3C illustrates a schematic flowchart of a method 305 for determining a height compensation in accordance with embodiments of the present disclosure. The method 305 may be implemented by the computing device 20 in FIG. 1. At 314, the computing device 20 determines whether the robot work cell 30 is configured with a camera 34 above a surface of the object carrier 32. If the computing device 20 determines that the robot work cell 30 is configured with a camera 34, the computing device 20 determines that the height compensation is zero at 316. In the case that a camera is used, the height of the object carrier would be identified as the distance from the surface of the virtual object carrier 42 to the work cell floor. In this case, there is no need to compensate the base height.

If the computing device 20 determines that the robot work cell 30 is not configured with a camera 34, the computing device 20 determines whether the robot work cell 30 is configured with a sensor 35 for sensing objects on a surface of the object carrier 31 at 318. If the computing device 20 determines that the robot work cell 30 is configured with a sensor 35, the computing device 20 obtains a virtual sensor height of a virtual sensor 45 corresponding to the sensor 35 in the virtual robot work cell 40 at 320. In the case that a sensor is used, the sensor is located on the edge of the surface. Therefore, the virtual sensor height of the virtual sensor 45 may indicate the original height of the surface of the virtual object carrier 42.

At 322, the computing device 20 obtains a virtual object height of a virtual object 43 at a point where the virtual object 43 appears on the virtual object carrier. In the virtual work cell 40, the initial position where the objects appear can be predefined. In the meantime, in this case the reference point of the virtual object carrier 42 is defined in the same height of the initial position. However, due to some simulation preference, the initial position may not be predefined on the surface of the virtual object carrier 42. Thus, the reference point of the virtual object carrier 42 is also not on the surface of the virtual object carrier 42.

At 324, the computing device 20 determines a difference between the virtual sensor height and the virtual object height as the height compensation. As discussed above, when the reference point of the virtual object carrier 42 is also not on the surface of the virtual object carrier 42, the height compensation can be determined based on the difference between the virtual sensor height and the virtual object height.

If the computing device 20 determines that the robot work cell 30 is also not configured with a sensor 35, the computing device 20 obtains an original virtual surface height of a surface of the virtual object carrier 42 at 326. The original virtual surface height indicates a distance from the surface of the virtual object carrier 42 to the floor of the virtual robot work cell 40 before the components are adjusted.

At 328, the computing device 20 obtains a virtual object height of a virtual object (33) at a point where the objects initially appear on the virtual object carrier. The virtual object height and the original virtual object carrier height may be obtained from the configuration of the virtual robot work cell 40.

At 330, the computing device 20 determines a difference between the original virtual object carrier height and the object virtual height as the height compensation. As discussed above, the difference between the original virtual object carrier height and the object virtual height can also indicate the distance from the reference point of the virtual object carrier 42 to the surface of the virtual object carrier 42. At this point, the determination procedures of the height compensation in different cases are described.

Back to FIG. 3A, after the base height and the height compensation are both determined, the computing device 20 adjusts a height of the virtual object carrier 42 to a target virtual height based on the base height and the height compensation at 306. In this way, by taking the cell configuration into consideration during determining the target height, an accurate target virtual height can be achieved.

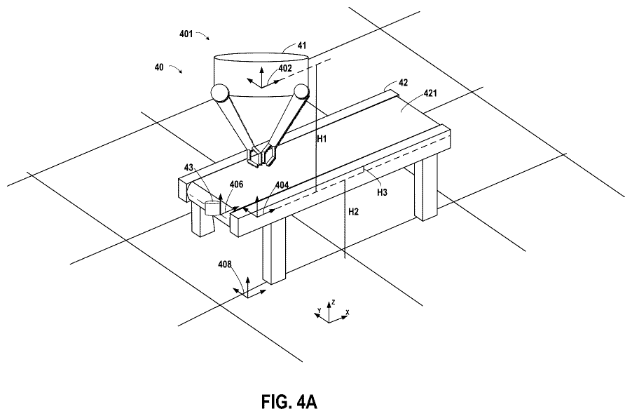

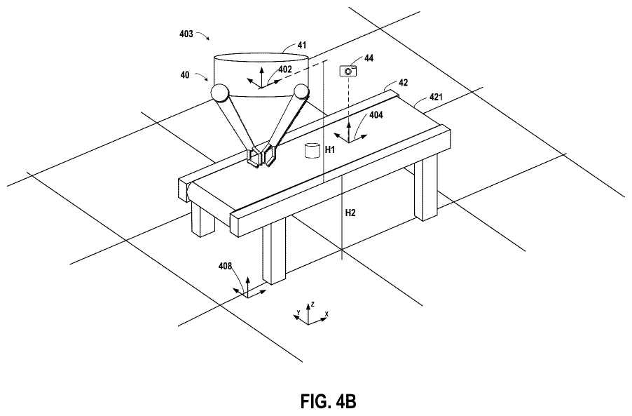

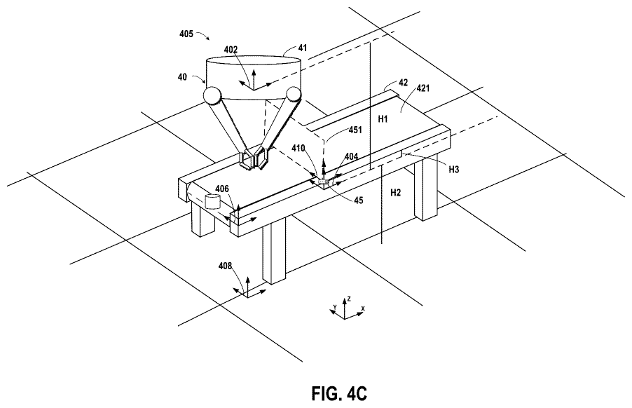

FIGS. 4A-4C illustrates schematic block diagrams of a virtual robot work cell 40 with different configurations in accordance with embodiments of the present disclosure where the object carrier is linear. The components in the figures have all been adjusted.

In particular, FIG. 4A illustrates a schematic block diagram 401 of a virtual robot work cell 40 without visual detection equipment. As illustrated in FIG. 4A, the virtual robot work cell 40 includes a virtual robot 41 configured with a robot coordinate system 402 and a virtual object carrier 42 configured with a carrier coordinate system 404. A virtual object 43 is configured to appear at the initial point on the virtual object carrier 42. The initial point is also the origin of the object coordinate system 406. As illustrated, the object coordinate system 406 is below the surface 421 of the virtual object carrier 42. Thus, the carrier coordinate system 404 is in the same horizontal plane with the object coordinate system 406. Therefore, the object coordinate system 406 is also below the surface 421.

In this embodiment, relative position may be comprised in the relative positioning information from the controller 10. The information may comprise six values. Namely, the relative positions in three orientation and three relative orientations of the carrier coordinate system of the object carrier 32 relative to the robot coordinate system of the robot 31. For example, the coordinate systems may be referred to as “base frame” in the robot operation system (ROS). In order to synchronize the positions of components in the real work cell and virtual work cell, the relative positions in three orientations will be determined. In the illustrated embodiment, the relative height derived from the relative positioning information is illustrated as H1. The height of the virtual robot 41, namely the height of the origin of the robot coordinate system 402 to the floor of the virtual robot work cell 40, is denoted as Hrobot. Therefore, the base height H2 can be determined as following:

$$H 2 = {H}_{robot} - H 1 \qquad ( 1 )$$

In order to determine the target height of the surface 421, a height compensation H3, namely the height of the surface 421 to the carrier coordinate system 404, must be determined. Since the height compensation H3 is the same as that before the surface is adjusted, H3 can be determined based on the original surface height H_{original_surface} of the surface and the original object height H_{original_object} of the object coordinate system 406 which can be read from the configuration of the virtual robot work cell 40. The height compensation can be determined as follows:

$$H 3 = {H}_{original \_ surface} - {H}_{original \_ object} . \qquad ( 2 )$$

Finally, the target height H_{target} of the surface 421 can be determined as follows:

$${H}_{target} = H 2 + H 3 = {H}_{robot} - H 1 + {H}_{original \_ surface} - {H}_{original \_ object} . \qquad ( 3 )$$

In some embodiment, after the height is adjusted, the positons in the x and y orientation will be directly adjusted based on the relative positon in the x and y orientation according to the relative position. In addition, the orientation can also be adjusted based on the relative orientations in the relative positioning information.

FIG. 4B illustrates a schematic block diagram 403 of a virtual robot work cell 40 with a camera 44. As illustrated in FIG. 4B, the virtual robot work cell 40 is configured with a virtual camera 44. The virtual camera 44 is located right above the carrier coordinate system 404. In this embodiment, since the virtual camera 44 is provided, the carrier coordinate system 404 is on the surface of the virtual object carrier 42. Therefore, the height compensation is null. Therefore, the target height H_{target} is equal to base height H2, and can be determined according to equation (1) as follows:

$${H}_{target} = H 2 = {H}_{robot} - H 1. \qquad ( 4 )$$

In addition to adjusting the position of other components as discussed above, after the height is adjusted, the virtual camera 44 will be adjusted to the positon right above the carrier coordinate system 404 for example in its original height.

FIG. 4C illustrates a schematic block diagram 405 of a virtual robot work cell 40 with a virtual sensor 45. As illustrated in FIG. 4C, the virtual sensor 45 is located at edge of the surface 421 and configured with a sensor coordinate system 410. The object coordinate system 406 and the carrier coordinate system 404 are in the same horizontal plane and below the surface 421 of the virtual object carrier 42. In the illustrated embodiment, the relative height derived from the relative position is illustrated as H1. The height of the virtual robot 41 is denoted as Hrobot. Therefore, the base height H2 can be determined according to the equation (1). In order to determine the target height of the surface 421, a height compensation H3 must be determined. According to FIG. 4C, the height compensation H3 can be determined based on the sensor height Hₛₑₙₛₒᵣ of the virtual sensor 45 and the object height H_{object} of the object coordinate system 406 which can be read from the configuration of the virtual robot work cell 40. The height compensation can be determined as follows:

$$H 3 = {H}_{sensor} - {H}_{object} . \qquad ( 5 )$$

Finally, the target height H_{target} of the surface 421 can be determined as follows:

$${H}_{target} = H 2 + H 3 = {H}_{robot} - H 1 + {H}_{sensor} - {H}_{object} . \qquad ( 6 )$$

In addition to adjusting the position of other components as discussed above, after the height is adjusted, the virtual sensor 45 will be adjusted based on H_{target} and other relative positions and orientations in the relative positioning information.

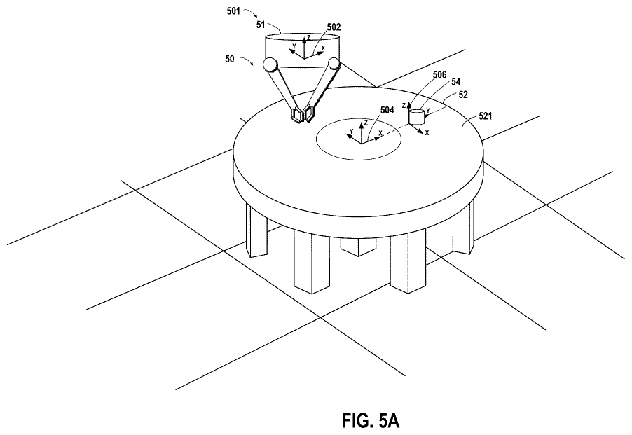

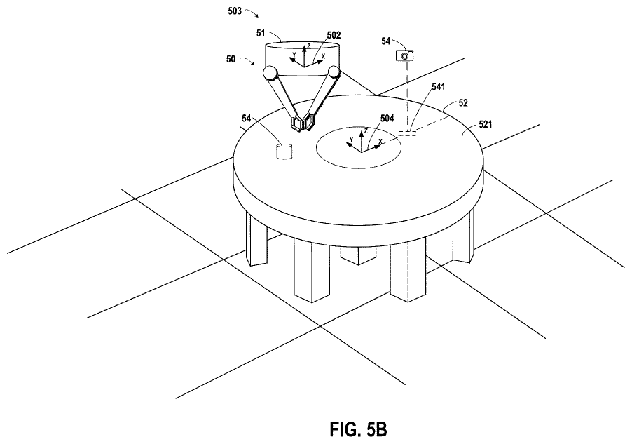

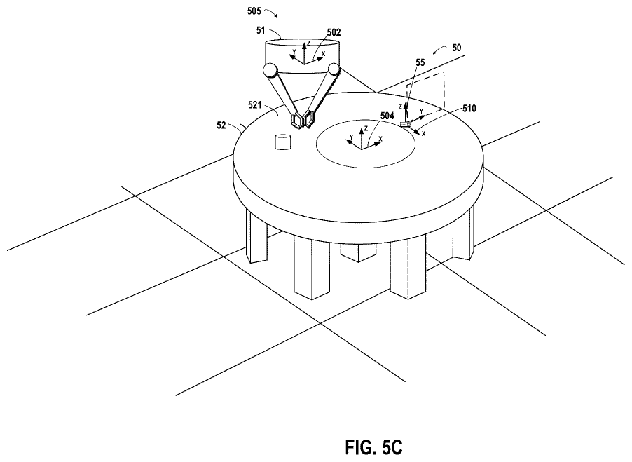

FIGS. 5A-5C illustrate schematic block diagrams of a virtual robot work cell with different configurations in accordance with embodiments of the present disclosure where the object carrier is circular. The height adjustment in the embodiments illustrated in FIGS. 5A-5C are substantially the same as that in the embodiments illustrated in FIGS. 4A-4C. Therefore, the description of the height adjustment will be omitted here.

In particular, FIG. 5A illustrates a schematic block diagram 501 of a virtual robot work cell 40 without visual detection equipment. As illustrated in FIG. 5A, the virtual robot work cell 50 includes a virtual robot 51 configured with a robot coordinate system 502 and a circular virtual object carrier 52 configured with a carrier coordinate system 504. The carrier coordinate system 504 is located in the center of the circular virtual object carrier 52. A virtual object 53 is configured to appear at the initial point on the virtual object carrier 52. The initial point is also the origin of the object coordinate system 506. As illustrated, y orientation of the object coordinate system 506 is orientated in the same direction as the x orientation of the carrier coordinate system 504.

In this embodiment, after the height is adjusted, the positons of the circular virtual object carrier 52 in the x and y orientation will be directly adjusted based on the relative positon in the x and y orientation. The position of object coordinate system 506 is adjusted based on the adjustment made on the circular virtual object carrier 52. For example, an adjustment distance of the circular virtual object carrier 52 may be determined as an adjustment vector from the original position to the target positon. Then, the position of object coordinate system 506 can be adjusted with the adjustment vector.

FIG. 5B illustrates a schematic block diagram 503 of a virtual robot work cell 50 with a camera 44. As illustrated in FIG. 5B, the virtual robot work cell 50 is configured with a virtual camera 54. A projection 541 of the virtual camera 54 on the surface 521 of the circular virtual object carrier 52 is located on the radius in x orientation of the carrier coordinate system 504.

After the positons of the circular virtual object carrier 52 in the x and y orientation is adjusted. The position of the virtual camera 54 is adjusted so that the projection 541 is still on the radius in x orientation of the carrier coordinate system 504.

FIG. 5C illustrates a schematic block diagram 505 of a virtual robot work cell 50 with a virtual sensor 55. As illustrated in FIG. 5C, the virtual sensor 55 is located at an inner edge of the surface 521 of and configured with a sensor coordinate system 510. The y orientation of sensor coordinate system 510 is parallel to the x orientation of the carrier coordinate system 504.

After the positons and orientations of the circular virtual object carrier 52 are adjusted. Since position and orientation between the virtual sensor 55 and the circular virtual object carrier 52 are fixed, the positions of the virtual sensor 55 is adjusted parallel to the adjustment of the he circular virtual object carrier 52.

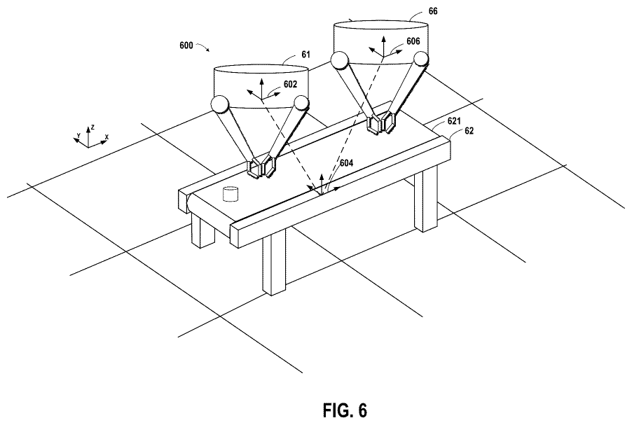

FIG. 6 illustrates a schematic block diagram 600 of a virtual robot work cell 60 with two robots in accordance with embodiments of the present disclosure. It should be appreciated that two robots are only exemplar. The virtual robot work cell 60 may have any number of robots.

The virtual robot work cell 60 corresponds to a real robot work cell including two robots and a linear object carrier 62. Each one of the two robots is controlled by a controller. Accordingly, the virtual robot work cell 60 includes a first virtual robot 61 and a second virtual robot 66 corresponding to two robots as well as a virtual linear object carrier 62. In this embodiment, the first virtual robot 61 serves as a basis for position and orientation adjustment. That is, the locations and orientations of components in the work cell will be updated relative to the first virtual robot 61 which is the one closest to the start of the virtual linear object carrier 62. The positon and orientation adjustment of the virtual linear object carrier 62 and other optional components can be performed according to methods discussed above. Hereinafter, the positon and orientation adjustment of the second virtual robot 66 will be described.

In the most common cases which are also the cases of the embodiment illustrated in FIG. 6, two carrier coordinate systems in the two controllers are defined at the same location and orientation in the work cell, although they are expressed by different values in different controllers. Therefore, relative positioning information MI1 and relative positioning information MI2, which are two positioning matrices, are read from two different controllers. MI1 indicates the relative positons of object carrier relative to the first robot and MI2 indicates the relative positons of object carrier relative to the second robot. In order to adjust positon and orientation of the second robot relative to the first robot, the relative positioning information MB between the second robot and the first robot is determined by:

$${M}_{I 3 =} {M}_{I 1} * inv ( {M}_{I 2} ) \qquad ( 7 )$$

where inv(M_{I2}) indicates inverse of M_{I2} which represents the relative position and orientation of the second robot relative to the object carrier. That is, at first, the coordinate system of the object carrier relative to the second robot is converted to the coordinate system of the second robot relative to the object carrier. Then, the coordinate system of the second robot relative to the object carrier is converted to the coordinate system of the second robot relative to the first robot via the coordinate system of the object carrier relative to the first robot. After the M_{I3} is determined, the position and orientation of the second virtual robot 66 can be tuned based thereupon.

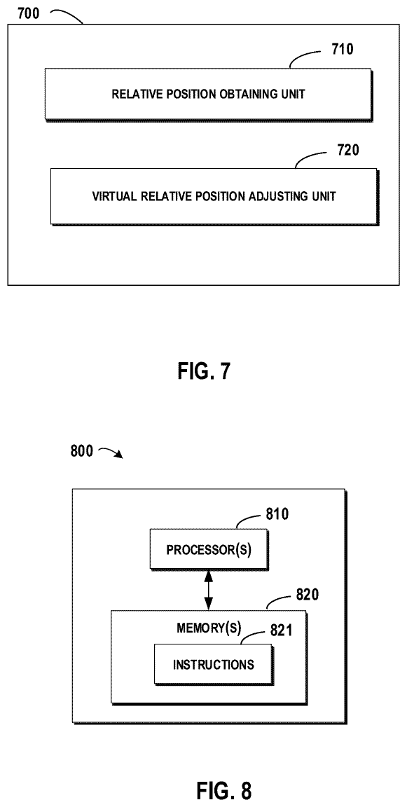

The preceding paragraphs having described detailed steps of the methods 200 and 300, in some embodiments of the present disclosure, the methods 200 and 300 may be implemented by corresponding apparatuses. FIG. 7 illustrates a schematic diagram of a position adjusting apparatus 700 for adjusting a virtual relative position in a virtual robot work cell 40. The apparatus comprises a relative position obtaining unit 710 configured to obtain, from a controller 10 for controlling a robot 31 in a robot work cell 30, a relative position between the robot 31 and an object carrier 32 in the robot work cell 30. The apparatus further comprises a virtual relative position adjusting unit 720 configured to adjust, in a virtual robot work cell 40 simulating the robot work cell 30, a virtual relative position between a virtual robot 41 corresponding to the robot 31 and a virtual object carrier 42 corresponding to the object carrier 32 based on the relative position.

In some example embodiments, the relative position obtaining unit 710 comprises: a base height determining module configured to determine a base height of the virtual object carrier 42 based on the relative position and a virtual robot height of the virtual robot 41; a height compensation determining module configured to determine a height compensation based on a cell configuration of the robot work cell 30; and a height adjusting configured to adjust a height of the virtual object carrier 42 based on the base height and the height compensation.

In some example embodiments, adjusting the relative position obtaining unit 710 further comprises: a virtual target horizontal position determining module configured to determine a virtual target horizontal position of the virtual object carrier 42 based on the relative position and a virtual horizontal position of the virtual robot 41; and a virtual position adjusting module configured to adjust a virtual position of the virtual object carrier 42 to the virtual target horizontal position.

In some example embodiments, the base height determining module comprises: a virtual robot height obtaining component configured to obtain the virtual robot height of the virtual robot 41; a relative height determining component configured to determine a relative height based on the relative position; and a first difference determining component configured to determine a difference between the virtual robot height and the relative height as the base height.

In some example embodiments, the height compensation determining module comprises: an original height obtaining component configured to obtain an original virtual surface height of a surface of the virtual object carrier 42; a virtual object height obtaining component configured to obtain a virtual object height of an virtual object 43 at a point where the virtual object 43 appears on the virtual object carrier 42; a second difference determining component configured to a difference between the original virtual surface height and the object virtual height as the height compensation.

In some example embodiments, the height compensation determining module comprises: a determining component configured to determine that the height compensation is zero in response to determining that the robot work cell 30 is configured with a camera 34 above a surface of the object carrier 32.

In some example embodiments, the apparatus further comprises: a position adjusting unit configured to adjust a position of a virtual camera 44 based on the virtual target horizontal position.

In some example embodiments, the height compensation determining module comprises: a virtual sensor height obtaining component configured to obtain a virtual sensor height of a virtual sensor 45 corresponding to the sensor 35 in the virtual robot work cell 40 in response to determining that the robot work cell 30 is configured with a sensor 35 for sensing objects on a surface of the object carrier 32; a virtual object height obtaining component configured to obtain a virtual object height of a virtual object 43 at a point where the virtual object 43 appears on the virtual object carrier 42; and a third difference determining component configured to determine a difference between the virtual sensor height and the virtual object height as the height compensation.

In some example embodiments, the apparatus further comprises a position adjusting unit to adjust a position of the virtual sensor 45 based on the virtual target horizontal position.

In some example embodiments, the apparatus further comprises: a virtual robot orientation obtaining unit configured to obtain a virtual robot orientation of the virtual robot 41 in response to determining that the object carrier 32 is linear; and a virtual orientation adjusting unit configured to adjust a virtual orientation of the virtual object carrier 42 based on the virtual robot orientation and a relative orientation between the robot 31 and an object carrier 32.

In some example embodiments, the apparatus further comprises: a cente determining unit configured to determine a center of the virtual object carrier 42 as an origin of a virtual object carrier coordinate system of the virtual object carrier 42 in response to determining that the object carrier 32 is circular; and an orientation adjusting unit configured to adjust an orientation of the virtual object carrier coordinate system based the virtual robot orientation and a relative orientation between the robot 31 and an object carrier 32.

In some example embodiments, the apparatus further comprises: a further relative position obtaining unit configured to obtain, from a further controller for controlling the further robot, a further relative position between the object carrier 32 and the further robot in response to determining that the robot work cell 40 further comprises a further robot; and a virtual position adjusting module configured to adjust, in the virtual robot work cell 40, a virtual position of a virtual further robot corresponding to the further robot based on the relative position and the further relative position.

In some embodiments of the present disclosure, a system is provided for implementing the above methods 200, 301, 303 and 305. FIG. 8 illustrates a schematic diagram of a system 800 for implementing a method in accordance with embodiments of the present disclosure. The system 800 comprises: a computer processor 810 coupled to a computer-readable memory unit 820, the memory unit 820 comprising instructions 822 that when executed by the computer processor 810 implements the methods 200, 301, 303 or 305.

In some embodiments of the present disclosure, a computer readable medium for managing a camera system is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 and 3A-3C. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for adjusting a virtual relative position in a virtual robot work cell, the method comprising:
obtaining, from a controller for controlling a robot in a robot work cell, a relative position between the robot and an object carrier in the robot work cell; and
adjusting, in the virtual robot work cell simulating the robot work cell, a virtual relative position between a virtual robot corresponding to the robot and a virtual object carrier corresponding to the object carrier based on the relative position.

2. The method of claim 1, wherein adjusting the virtual relative position comprises:
determining a base height of the virtual object carrier based on the relative position and a virtual robot height of the virtual robot;
determining a height compensation based on a cell configuration of the robot work cell; and
adjusting a height of the virtual object carrier based on the base height and the height compensation.

3. The method of claim 2, wherein adjusting the virtual relative position further comprises:
determining a virtual target horizontal position of the virtual object carrier based on the relative position and a virtual horizontal position of the virtual robot; and
adjusting a virtual position of the virtual object carrier to the virtual target horizontal position.

4. The method of claim 2, wherein determining the base height comprises:
obtaining the virtual robot height of the virtual robot;
determining a relative height based on the relative position; and
determining a difference between the virtual robot height and the relative height as the base height.

5. The method of claim 2, wherein determining the height compensation comprises:
obtaining an original virtual surface height of a surface of the virtual object carrier;
obtaining a virtual object height of a virtual object at a point where the virtual object appears on the virtual object carrier; and
determining a difference between the original virtual surface height and the object virtual height as the height compensation.

6. The method of claim 3, wherein determining the height compensation comprises:
in response to determining that the robot work cell is configured with a camera above a surface of the object carrier, determining that the height compensation is zero.

7. The method of claim 6, further comprising:
adjusting a position of a virtual camera based on the virtual target horizontal position.

8. The method of claim 2, wherein determining the height compensation comprises:
in response to determining that the robot work cell is configured with a sensor for sensing objects on a surface of the object carrier, obtaining a virtual sensor height of a virtual sensor corresponding to the sensor in the virtual robot work cell;
obtaining a virtual object height of a virtual object at a point where the virtual object appears on the virtual object carrier; and
determining a difference between the virtual sensor height and the virtual object height as the height compensation.

9. The method of claim 8, further comprising:
adjusting a position of the virtual sensor based on the virtual target horizontal position.

10. The method of claim 1, further comprising:
in response to determining that the object carrier is linear, obtaining a virtual robot orientation of the virtual robot; and
adjusting a virtual orientation of the virtual object carrier based on the virtual robot orientation and a relative orientation between the robot and an object carrier.

11. The method of claim 1, further comprising:
in response to determining that the object carrier is circular, determining a center of the virtual object carrier as an origin of a virtual object carrier coordinate system of the virtual object carrier; and
adjusting an orientation of the virtual object carrier coordinate system based the virtual robot orientation and a relative orientation between the robot and an object carrier.

12. The method of claim 1, further comprising:
in response to determining that the robot work cell further comprises a further robot, obtaining, from a further controller for controlling the further robot, a further relative position between the object carrier and the further robot; and
adjusting, in the virtual robot work cell, a virtual position of a virtual further robot corresponding to the further robot based on the relative position and the further relative position.

13. An apparatus for adjusting a virtual relative position in a virtual robot work cell, the apparatus comprising:
a relative position obtaining unit configured to obtain, from a controller for controlling a robot in a robot work cell, a relative position between the robot and an object carrier in the robot work cell; and
a virtual relative position adjusting unit configured to adjust, in a virtual robot work cell simulating the robot work cell, a virtual relative position between a virtual robot corresponding to the robot and a virtual object carrier corresponding to the object carrier based on the relative position.

14. A system for adjusting a virtual relative position in a virtual robot work cell, comprising: a computer processor coupled to a computer-readable memory unit, the memory unit comprising instructions that when executed by the computer processor implement the method according to claim 1.

15. A non-transitory computer readable medium having instructions stored thereon, the instructions, when executed on at least one processor, cause the at least one processor to perform the method according to claim 1.

16. The method of claim 3, wherein determining the base height comprises:
obtaining the virtual robot height of the virtual robot;
determining a relative height based on the relative position; and
determining a difference between the virtual robot height and the relative height as the base height.

17. The method of claim 3, wherein determining the height compensation comprises:
obtaining an original virtual surface height of a surface of the virtual object carrier;
obtaining a virtual object height of a virtual object at a point where the virtual object appears on the virtual object carrier; and
determining a difference between the original virtual surface height and the object virtual height as the height compensation.
